(19) United States
(12) Patent Application Publication
(10) Pub. No.: US 2015/0269828 A1
(43) Pub. Date: Sep. 24, 2015

(54) SMART REMINDER SYSTEM AND SMART REMINDER METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: DONG-BO WANG, Wuhan (CN)

(21) Appl. No.: 14/682,719

(22) Filed: Apr. 9, 2015

(30) Foreign Application Priority Data
Mar. 19, 2014 (CN) 201510120424.6

(51) Int. Cl. G08B 21/04

(52) U.S. Cl. CPC G08B 21/0461

(57) ABSTRACT

A smart reminder system includes an intelligent web camera and an electronic device. The intelligent web camera includes a detecting module, and the electronic device includes a determining module coupled to the detecting module and a warning module coupled to the determining module. The detecting module detects a position of at least one eye to obtain a gaze direction of the at least one eye, and the determining module determines whether the gaze direction satisfies with a standard. When the gaze direction does not satisfies with the standard, the warning module warns a user to adjust the posture to a standard sitting posture. The disclosure further provides a smart reminder method.

### FIELD

The subject matter herein generally relates to a smart reminder system and a smart reminder method.

### BACKGROUND

An electronic device, such as a computer, is usually used in everyday life. Many people maintain a stationary posture when using the computer for a long time which can have long lasting influence on health.

### BRIEF DESCRIPTION OF THE DRAWINGS

Implementations of the present technology will now be described, by way of example only, with reference to the attached figures.

FIG. 1 is an isometric view of one embodiment of a smart reminder system.

FIG. 2 is a block diagram of one embodiment of function modules of the smart reminder system of FIG. 1.

FIG. 3 is a flowchart of one embodiment of a smart reminder method using the smart reminder system of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a smart reminder system. The smart reminder system includes an intelligent web camera and an electronic device. The intelligent web camera includes a detecting module, and the electronic device includes a determining module coupled to the detecting module and a warning module coupled to the determining module. The detecting module detects a position of at least one eye to obtain a gaze direction, and the determining module decides whether the gaze direction satisfies a standard. When the gaze direction does not satisfy the standard, the warning module warns a user to adjust posture to a standard sitting posture.

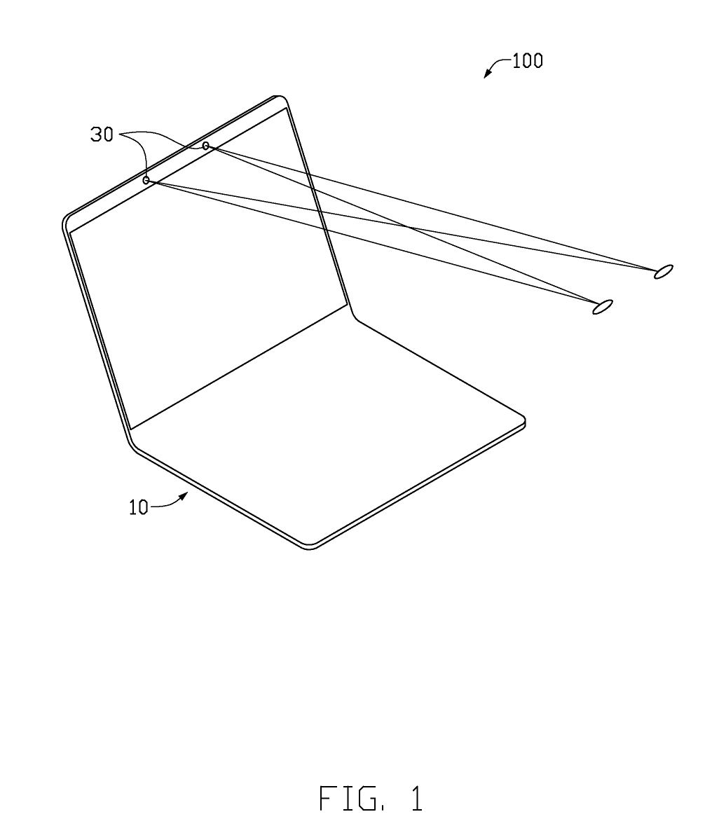

FIG. 1 illustrates an embodiment of a smart reminder system 100. The smart reminder system 100 can include an electronic device 10 and an intelligent web camera 30 secured to the electronic device 10. In at least one embodiment, the electronic device 10 can be a computer, and the intelligent web camera 30 can be secured to a display of the electronic device 10.

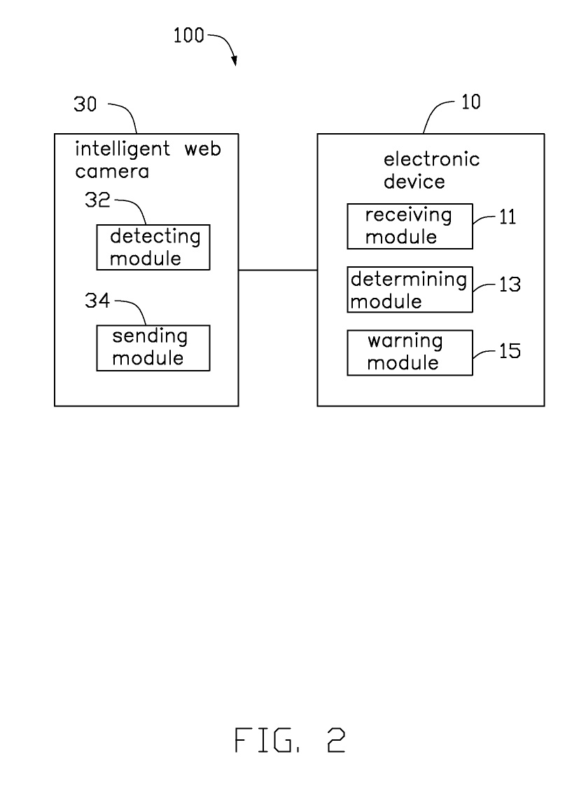

FIG. 2 illustrates an embodiment of the smart reminder system 100. The intelligent web camera 30 can include a detecting module 32 and a sending module 34 coupled to the detecting module 32. The detecting module 32 is configured to detect the position of at least one eye to obtain a gaze direction. The sending module 34 is configured to send a signal of the gaze direction to the electronic device 10.

The electronic device 10 can include a receiving module 11, a determining module 13 coupled to the receiving module 11, and a warning module 15 coupled to the determining module 13. The receiving module 11 is configured to receive the signal of the gaze direction. The determining module 13 is configured to determine whether the gaze direction satisfies a standard. In at least one embodiment, the standard can be an angle range, such as 0-45 degrees, defined by the gaze direction and the electronic device 10. The angle range can be defined by the electronic device 10. When the gaze direction does not satisfy the standard, the warning module 15 is configured to warn the user to adjust posture to a standard sitting posture. In at least one embodiment, the warning module 15 can offer a warning signal to the user, and the warning signal can be an audio signal, a light-emitting diode, or a displaying character.

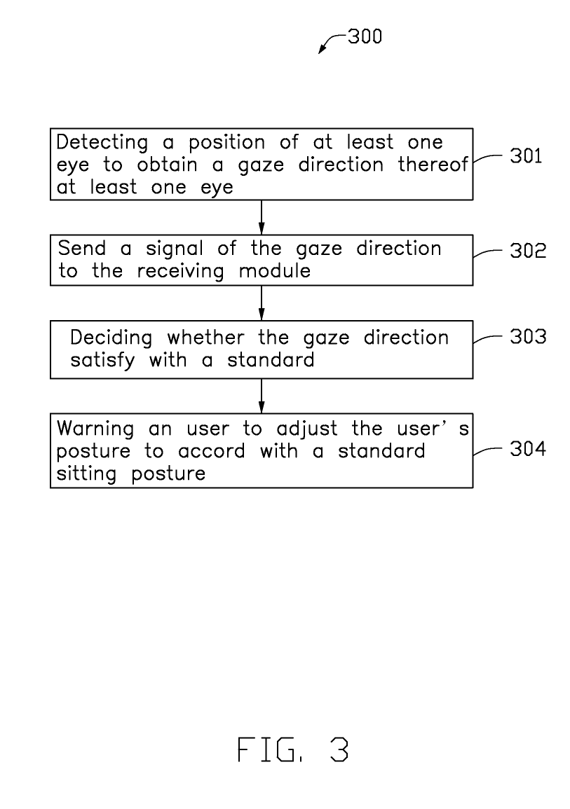

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the detecting module 32 of the intelligent web camera 30 detects the position of at least one eye to obtain a gaze direction.

At block 302, the sending module 34 of the intelligent web camera 30 sends a signal of the gaze direction to the receiving module 11 of the electronic device 10.

At block 303, the determining module 13 determines whether the gaze direction satisfies a standard. In at least one embodiment, the standard can be an angle range defined by the gaze direction and the electronic device 10.

At block 304, when the gaze direction does not satisfy the standard, the warning module 15 warns the user to adjust posture to a standard sitting posture, so that the gaze direction of the user can be the standard. In at least one embodiment, the warning module 15 can send warning via an audio signal, a light-emitting diode, or a displaying character.

The embodiments shown and described above are only examples. Many details are often found in the art such as the other features of a smart reminder system. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, especially in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. A smart reminder system comprising:
an intelligent web camera comprising a detecting module; and
an electronic device comprising a determining module coupled to the detecting module; and
a warning module coupled to the determining module,
wherein the detecting module is configured to detect a position of at least one eye to obtain a gaze direction thereof, determine that the gaze direction does not satisfy a standard, and upon such determination, send a signal to the warning module; and wherein the warning module is configured to emit a warning upon receipt of the signal.

2. The smart reminder system of claim 1, wherein the warning module is further configured to offer a warning signal.

3. The smart reminder system of claim 2, wherein the warning signal is a voice signal, a light-emitting diode, or a displaying character.

4. The smart reminder system of claim 1, wherein the standard is an angle range defined by the gaze direction and the electronic device.

5. The smart reminder system of claim 1, wherein the intelligent web camera further comprises a sending module configured to send the gaze direction to the electronic device, and the electronic device further comprise a receiving module configured to receive the gaze direction.

6. The smart reminder system of claim 1, wherein the electronic device is a computer, and the intelligent web camera is secured to a display of the computer.

7. A smart reminder method comprising:
detecting a position of at least one eye to obtain a gaze direction thereof by a detecting module of an intelligent web camera;
determining whether the gaze direction satisfies with a standard by a determining module of an electronic device; and
emitting a warning by a warning module of the electronic device, when the gaze direction does not satisfy with the standard.

8. The smart reminder method of claim 7, further comprising: offering a warning signal to the user by the warning module.

9. The smart reminder method of claim 8, wherein the warning signal is a voice signal, a light-emitting diode, or a displaying character.

10. The smart reminder method of claim 7, wherein the standard is an angle range defined by the gaze direction and the electronic device.

11. The smart reminder method of claim 7, further comprising: sending the gaze direction of the at least one eye to the electronic device by a sending module of the intelligent web, and receiving the gaze direction of the at least one eye by a receiving module of the electronic device.

12. The smart reminder method of claim 7, wherein the electronic device is a computer, and the intelligent web camera is secured to a display of the computer.
